(19) United States
(12) Patent Application Publication
(10) Pub. No.: US 2026/0205885 A1
(43) Pub. Date: Jul. 16, 2026

(54) SECURE ELEMENT, TERMINAL DEVICE AND METHOD FOR CONFIGURING A NETWORK SEARCH

(71) Applicant: Giesecke+Devrient Mobile Security Germany GmbH, Munchen (DE)

(72) Inventors: Michael SCHNELLINGER, Munchen (DE); Martin ROESNER, Munchen (DE)

(21) Appl. No.: 19/447,342

(22) Filed: Jan. 13, 2026

(30) Foreign Application Priority Data
Jan. 15, 2025 (DE) 10 2025 101 378.0

(51) Int. Cl. H04W 28/18; H04W 8/04

(52) U.S. Cl. CPC H04W 28/18; H04W 8/04

(57) ABSTRACT

A secure element is for communication via a communication network is provided. The secure element includes: a memory area in which a home network configuration and a country identifier are stored; and a control device. The control device is configured to: receive a new country identifier during a registration attempt into the communication network; if the new country identifier differs from the stored country identifier, write a network identifier corresponding to the current country identifier into the home network configuration; and continue the registration attempt.

### TECHNICAL FIELD OF THE INVENTION

The invention relates to a secure element, a terminal device and a corresponding method for configuring a network search, in particular for use cases in the field of the Internet of Things (IoT).

### TECHNICAL BACKGROUND OF THE INVENTION

Secure elements within the scope of the present disclosure are hardware and/or software components, by means of which a terminal device can register for a communication network of a provider or network operator or log into the communication network.

Through the Internet of Things, many terminal devices have been developed and provided, which are set up to transmit a wide variety of data via a communication network to servers, for example of a cloud application. Such terminal devices can be used, for example, as energy-autonomous units for monitoring objects, vehicles, goods, etc., in order to track their position and/or state ideally in real time. These terminal devices can be subject to frequent changes of location and can therefore be forced to frequently change the communication network. These terminal devices can be used as so-called track-and-trace devices in various fields such as logistics, supply chain management, container tracking and theft protection.

In a secure element the order in which connection attempts with new communication networks are made is usually preconfigured. For public land mobile networks (PLMN) this order is specified, for example, in the standard ETSI TS 123122 (V18.7.1). For this purpose, at least one home network, for example home PLMN (HPLMN), is configured in the secure element. In addition, networks or PLMNs can be configured by a user or an operator in the event that the home network is not available.

In the event of a communication network change, connection attempts with each of the home networks are first carried out in the order in which they are listed in the secure element and, if necessary, further connection attempts with the relevant networks specified by the user and/or operator are carried out subsequently. That is to say, in the case of a terminal device which frequently changes its location and possibly has hardly any access to the HPLMN, a plurality of connection attempts are required for each communication network change until the terminal device can register again in a new communication network.

Connected terminal devices for the Internet of Things, in particular track-and-trace devices, however, have a limited battery capacity which is often neither expandable nor regenerable. Each connection attempt is energy-intensive, with the result that communication network changes can have a considerable influence on the runtime of the terminal devices.

In special cases, terminal devices can be configured only for communication via home networks, for example in order to further reduce manufacturing and/or operating costs. In the case of this configuration, it should be assumed that the terminal device is used in any case only in the field of the home networks. This configuration may work for home networks with sufficiently large-area coverage in a few countries of the world. In other regions which comprise, for example, a multiplicity of state boundaries, however, this configuration considerably restricts the use of such terminal devices.

### SUMMARY OF THE INVENTION

Thus, there is a need for a secure element, for a terminal device and for a method corresponding thereto which is configured to a communication network change which is as energy-efficient as possible.

There is also a need for a secure element and for a method corresponding thereto in order to extend the service life or running time of existing, energy-autonomous terminal devices which are configured for communication via a communication network.

It is a further object of the invention to provide a secure element or a terminal device which has improved connectivity to new communication networks starting from originally set home networks.

At least one of these objects is achieved by the secure element, the terminal device and/or the method according to the respective independent claims. Developments thereof are specified in the respective dependent claims.

The invention is based on the concept of shortening the network search for a secure element or a terminal device equipped therewith in that one or more relevant network identifiers are dynamically written into the home network configuration.

According to one aspect of the present invention, a secure element for communication via a communication network is provided. The secure element comprises: a memory area in which a home network configuration and a country identifier are stored; and a control device. The control device is configured to: receive a new country identifier during a registration attempt into the communication network; if the new country identifier differs from the stored country identifier, write a network identifier corresponding to the current country identifier into the home network configuration; and continue the registration attempt. The control device is thus configured to write a network identifier corresponding to the new country identifier into the home network configuration.

According to a further aspect of the present invention, a terminal device for communication via a communication network is provided. The terminal device comprises a secure element according to an aspect of the present invention; a battery; and a transceiver. The transceiver is configured to search for networks and determine the new country code.

According to a further aspect of the present invention, a method for configuring a network search for a registration attempt of a secure element into a communication network is provided. The method comprises: receiving a new country identifier; comparing the new country identifier with a country identifier stored in the secure element; and if the new country identifier differs from the stored country identifier: determining a network identifier corresponding to the new country identifier; and writing the network identifier into the home network configuration.

According to a further aspect of the present invention, a machine-readable storage medium is provided. The machine-readable storage medium comprises instructions which, when executed by a control device, in particular a secure element, cause the latter to carry out the method according to an aspect of the present invention.

The secure element, a terminal device based thereon and a method corresponding to the secure element have in common to determine a network identifier based on a new country identifier corresponding to this country identifier and to enrich the home network configuration by this determined network identifier. As a result, a transceiver coupled to the secure element, which in any case first searches the home network configuration for available communication networks, can find a communication network corresponding to the new country identifier more quickly. The network search can thus be shortened considerably, in particular in the event of a communication network change.

The secure element, the terminal device and/or the method may comprise at least one of the following features:

The communication network may be a PLMN within the scope of the present disclosure. The communication network may be identifiable by a network identifier, e. g., a PLMN identifier or PLMN ID. The network identifier may be globally unambigious. The network identifier may comprise a country code, e. g., a mobile country code (MCC). The network identifier may comprise a mobile network code (MNC).

A secure element, abbreviated SE, within the meaning of the invention is an electronic module reduced in size and resource scope, which may comprise a control unit (microcontroller) and at least one interface (data interface) for communication with entities located outside the secure element, such as terminal devices, servers, etc. For instance, this communication takes place via a connection protocol, in the case of a secure element in particular via a protocol according to the standard ETSI TS 102221, GSMA SGP.31 or GSMA SGP.32.

The secure element may also be a software component in a trustworthy part of an operating system, a so-called trusted execution environment (TEE) of the device.

The secure element may also be an integral component of a larger integrated circuit, e.g. a modem or an application processor. Such UICCs are referred to as “integrated UICC”, “integrated TRE”, “integrated eUICC” or “integrated SE”. Such secure elements are permanently integrated in an SoC as an integrated processor block and may be connected via an in-chip bus.

The home network configuration may comprise a list with network identifiers of the home networks. The home network configuration may be stored in a base file (elementary file, EF) in the memory area of the secure element. The home network configuration may comprise a list with network identifiers of home equivalent networks.

A registration attempt may be initialized by a transceiver to which the secure element is connected. A registration attempt may be initialized, for example, by means of an AT command. The term “registration attempt in a communication network” is used synonymously with the term “connection attempt to the communication network” within the scope of the present disclosure.

The secure element may receive the new country identifier from a transceiver to which the secure element is connected. For this purpose, the secure element or an applet in the secure element may be triggered within the scope of the Card Application Toolkit (CAT), such as according to the standard ETSI TS 102223 (V18.0.0). For example, the new country identifier may be transmitted to the secure element as an MCC in the form of a “LOCATION STATUS EVENT” and/or by the “PROVIDE LOCAL INFORMATION” instruction from the transceiver or a terminal comprising the transceiver. Alternatively, the new country identifier may be transmitted to the secure element by an external function or application. The new country identifier may be stored in the memory area of the secure element and/or replace the stored country identifier in the memory area of the secure element.

The secure element may read or determine the network identifier corresponding to the new or current country identifier, for short: “new network identifier”, from its own memory area. For example, network identifiers may be stored in the operator-side network configuration, in particular the operator-controlled PLMN (OPLMN). A network identifier may correspond to the new country identifier, for example, in that the network identifier comprises the new country identifier, in particular the MCC thereof.

By writing the network identifier corresponding to the new country identifier into the home network configuration, it can be ensured when continuing the registration attempt that a communication network corresponding to the new country identifier is specifically selected.

The network identifier corresponding to the new country identifier may be written into the home network configuration of the secure element primarily before the network identifier of the previous home network. The network identifier corresponding to the new country identifier may replace the network identifier of the previous home network. This configuration may reduce the number of connection attempts required in the event of a communication network change and thus improve the energy efficiency of the communication network change.

As a result, it can be ensured that a communication network corresponding to the new country identifier is directly selected when continuing the registration attempt. This configuration may considerably reduce the number of connection attempts required in the event of a communication network change and thus considerably improve the energy efficiency of the communication network change.

Furthermore, an operator-controlled network configuration may be stored in the memory area of the secure element. The operator-controlled or operator-specific network configuration may comprise a list of network identifiers. The operator-controlled network configuration may be configured in particular as an OPLMN in the secure element. The operator-controlled network configuration may comprise a multiplicity of network identifiers which each comprise a country identifier or a country code. That is to say, one or more network identifiers may be stored in the operator-controlled network configuration per country identifier. The control device may be configured to determine the network identifier corresponding to the new country identifier on the basis of the operator-controlled network configuration.

This configuration has the advantage that no additional connection whatsoever is required for determining a matching network identifier.

The operator-controlled network configuration may comprise a list of network identifiers which each correspond to a country identifier from a plurality of country identifiers. The operator-controlled network configuration may be stored as an elementary file operator public land mobile network (OPLMN). The operator of the home network, for example, could be considered as the operator. The OPLMN is easily accessible in the secure element, with the result that candidates for communication networks corresponding to the new country identifier can be determined particularly easily and effectively.

The control device may be configured to receive the network identifier from outside the secure element.

The home network configuration may comprise a list of equivalent home networks or home equivalent networks. The list of equivalent home networks is conventionally purely optional. However, if the home network configuration comprises a network identifier of a home equivalent network, this network identifier is processed in the same way as the network identifier of a home network. That is to say, in the case of a communication network search, not only the home network but also all home equivalent networks are searched by default. The list of equivalent home networks may be stored as an elementary file equivalent home public land mobile network (EHPLMN) in the memory area of the secure element. The elementary file EHPLMN, also referred to as EF_EHPLMN, may be specified according to the standard 3GPP TS 31.102. The control device may be configured to write the network identifier corresponding to the new country identifier into the list of equivalent home networks. Since a modem coupled to the secure element first searches for home networks, it finds a matching network more quickly if an entry in EF_EHPLMN matches one of the scanned networks. As a result, the time required for registering a device in a communication network can be considerably reduced. As a result, the energy consumption of the corresponding terminal device can likewise be considerably reduced.

The content of the EF_EHPLMN is designed to be static. However, according to one aspect of the invention, the content of the EF_EHPLMN can be managed dynamically, for example by a JavaCard applet and/or by an external application which may communicate with the secure element, with the result that the EF_EHPLMN always contains at least one network identifier of an available communication network which can be recognized as a home network, even in the event of any country change (for example as a track-and-trace terminal device).

This configuration has the advantage that the HPLMN does not have to be adapted. Consequently, the HPLMN cannot be accidentally corrupted by the solution according to one aspect of the invention, for example by injection of a faulty MNC. Since the network identifiers which are stored in the EHPLMN can act as equivalent to the network identifiers which are stored in the HPLMN, the technical effect of the solution according to one aspect of the invention may likewise be brought about in this configuration.

The control device may be configured to copy at least one network identifier of the operator-controlled network configuration, the country identifier of which corresponds to the new country identifier, from the operator-controlled network configuration into the list of equivalent home networks.

The copying of the network identifier corresponding to the new country identifier from the OPLMN into the EHPLMN may be interpreted as prioritizing the new network identifier with respect to a network identifier corresponding to the previous country identifier. The copying between two basic files or elementary files (EF) in the memory area of the secure element may be carried out particularly quickly and reliably. During the copying of the new network identifier, the EHPLMN may be overwritten with the new network identifier. This configuration prevents an accumulation of network identifiers in the EHPLMN in the secure element in the event of frequent communication network changes, for example in the case of track-and-trace applications. As a result of the overwriting of the network identifiers stored in the EHPLMN with the respectively relevant new network identifier, the number of connection attempts required in the event of a communication network change may be regularly limited to a minimum and thus further improve the energy efficiency of the communication network change and extend the runtime of a corresponding connected terminal device.

The control device may be configured to proactively trigger a “REFRESH” command in order to continue the registration attempt on the basis of the updated home network configuration. For example, the control device may be configured to instruct a terminal (device), which comprises the secure element, to carry out a restart of the secure element and/or to transmit a file change notification to the secure element.

The control device may be configured to continue the registration attempt directly after the reception of the new country identifier if the new country identifier is identical to the stored or previous country identifier. In this case, no rearrangement of the communication networks to be searched is required.

The terminal device comprises a battery. The battery may be permanently installed in the terminal device, i.e., not exchangeable. The battery may be a primary battery, i.e., not rechargeable. The runtime of the terminal device may accordingly be critically dependent on the capacity of the battery. Therefore, a secure element according to one of the preceding aspects of the invention which is contained in this terminal device may substantially extend the runtime of the terminal device on account of the saving of useless connection attempts or registration attempts.

The terminal device may further comprise a first interface between the transceiver and the secure element. The first interface may be specified, for example, by the CAT.

The transceiver may be configured, during a network search for the registration attempt, to search for communication networks which are preconfigured in the home network configuration and/or a user-specific network configuration and/or an operator-specific network configuration. The transceiver may be configured, during a network search for the registration attempt, to search only for those networks which are preconfigured in the home network configuration. The transceiver may be a modem.

The transceiver may be configured to transmit the determined new country code to the secure element. For this purpose, the secure element may proactively initiate or trigger the transceiver. The new country code may be transmitted to the secure element by means of the CAT.

The terminal device may further comprise a functional unit. The functional unit may be configured to equip the terminal device with a specific function, for example a track-and-trace function, a state and/or transport monitoring function and/or a behavior-based motor vehicle insurance function, without being restricted to these functions. The functional unit may be provided outside the secure element and/or outside the transceiver. The functional unit may comprise a control device and a sensor unit. The sensor unit may comprise a location sensor. Alternatively or additionally, the sensor unit may comprise an acceleration sensor, a temperature sensor, a humidity sensor, a rotation angle sensor and/or an environmental sensor. The control device of the functional unit may be configured to receive a location signal of the location sensor, to determine the new country identifier on the basis of the location signal and to provide the new country identifier to the secure element. The location sensor may be configured to determine coordinates of the terminal device, for example on the basis of a global navigation satellite system (GNSS), such as GPS, GLONASS, Galileo, Beidou, and so on. The location signal may comprise a position value. The position value may comprise geographical coordinates with longitude and latitude. The position value may comprise a route section or route progress along a predefined transport route.

The dynamic management of the home network configuration, in particular of the EF_EHPLMN, by the functional unit has the additional advantage that the management can be monitored better. In comparison with the control device of the secure element or an applet executed thereon, the functional unit itself can determine new country identifiers.

The control device of the functional unit may further be configured to determine, on the basis of the location signal, the new country identifier in each case for the current country or the current region and at least one adjacent neighboring country or at least one adjacent neighboring region. The control device of the functional unit may further be configured to provide the determined new country identifiers to the secure element. The control device of the functional unit may be configured to transmit the determined new country identifiers to the control device of the secure element and/or to write new network identifiers directly into the home network configuration on the basis of the new country identifiers. In this configuration, the home network configuration of the secure element can be prepared in a predictive manner, for example for communication network changes in the event of border crossings to a neighboring country.

The terminal device may further comprise a second interface between the functional unit and the secure element. Via the second interface, in particular the control device of the functional unit may be configured to transmit data to the control device of the secure element. The terminal device may further comprise a third interface between the functional unit and the secure element, via which the control device of the functional unit may be configured to write network identifiers directly into the home network configuration of the secure element.

In an exemplary application, a predetermined route or (transport) route may be transmitted to the control device of the functional unit. The control device may be configured to subdivide the route into communication network sections, i.e. into sections whose borders are predefined by the coverage of corresponding communication networks. In a simple approximation, these borders may be equated with national borders. The control device may be configured to determine the corresponding country code for each section and based thereon correspondingly new network identifiers. In this case, the home network configuration of the secure element may already be configured for all sections along the route, i.e. the respectively newly determined network identifier may be stored for each section.

The control device of the functional unit may further be configured to transmit the new country identifier or the new country identifiers to the control device of the secure element. Alternatively or additionally, the control device of the functional unit may be configured to write the respective new network identifier directly into the list of equivalent home networks, in particular if the control device knows or has knowledge of corresponding roaming partners.

The terminal device, in particular the transceiver of the terminal device, comprises a communication interface for communication via the communication network.

In a preferred embodiment, the control device of the functional unit may be configured to access the secure element, to carry out functions of the terminal device and to provide messages to be sent via the communication interface of the terminal device. Furthermore, the terminal device may comprise a secure communication unit. In some embodiments, the secure communication unit is the functional unit.

The method may further comprise: determining the network identifier corresponding to the new country identifier on the basis of an operator-controlled network configuration which is stored in the secure element; and/or writing the network identifier into a list of equivalent home networks which is stored in the secure element.

The method may further comprise determining the new country identifier by a transceiver, e. g., during the network search and/or by a functional unit outside the secure element on the basis of a location signal. In order to determine the new country identifier by the functional unit on the basis of the location signal, the functional unit may read and may comprise a look-up table.

The method may further comprise copying at least one network identifier of the operator-controlled network configuration, the country identifier of which corresponds to the new country identifier, from the operator-controlled network configuration, e. g., stored in the elementary file OPLMN, into the list of equivalent home networks, e. g., stored in the elementary file EHPLMN.

### BRIEF DESCRIPTION OF THE DRAWINGS

The invention or further embodiments and advantages of the invention will be explained in more detail below with reference to figures, wherein the figures merely describe exemplary embodiments of the invention. Identical components in the figures are provided with identical reference signs. The figures are not to be regarded as true to scale; individual elements of the figures may be shown exaggerated in size or exaggerated in simplified form. Optional elements are shown by dashed lines.

FIG. 1 shows a schematic illustration of a secure element according to an aspect of the disclosure.

FIG. 2 shows a schematic illustration of a secure element which is communicatively integrated or connected into a terminal device according to an aspect of the invention.

FIG. 3 shows a schematic illustration of a terminal device according to an aspect of the disclosure.

FIG. 4 shows a flowchart of a method for configuring a network search according to an aspect of the disclosure.

### DETAILED DESCRIPTION OF EXEMPLARY EMBODIMENTS

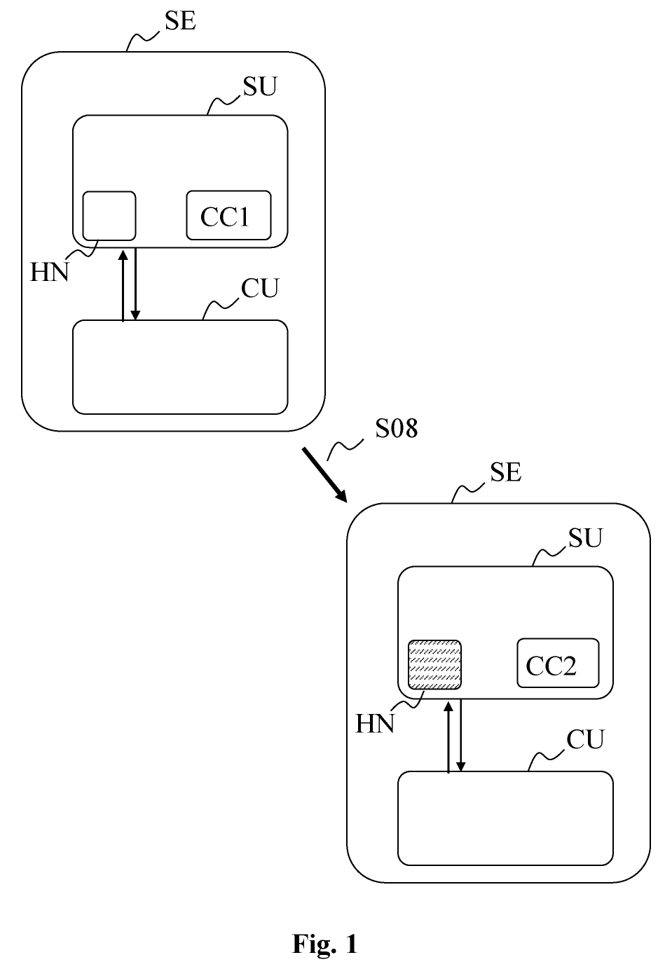

FIG. 1 schematically shows an exemplary embodiment of a secure element SE according to an aspect of the invention. The secure element SE has a memory area SU and a control device CU. A home network configuration HN and a country identifier CC1 are stored in the memory area SU. The country identifier CC1 may be referred to as the first country identifier.

The control device CU is configured to read out and/or write to the memory area SU.

FIG. 1 shows two states of the secure element SE which are logically linked to one another by carrying out method step S08 “writing the new network identifier into the home network configuration”. The difference between these two states of the secure element SE is concentrated on the home network configuration HN. In the first state, shown at the top left of FIG. 1, the home network configuration HN contains a preset network identifier for which a modem which is coupled to the secure element is intended to search after it has been started up. The preset network identifier of the home network configuration HN may comprise the first country identifier.

The control device CU is configured to receive a new country identifier CC2. The new country identifier CC2 is received during a registration attempt into the communication network which may correspond to the network identifier preconfigured in the home network configuration HN.

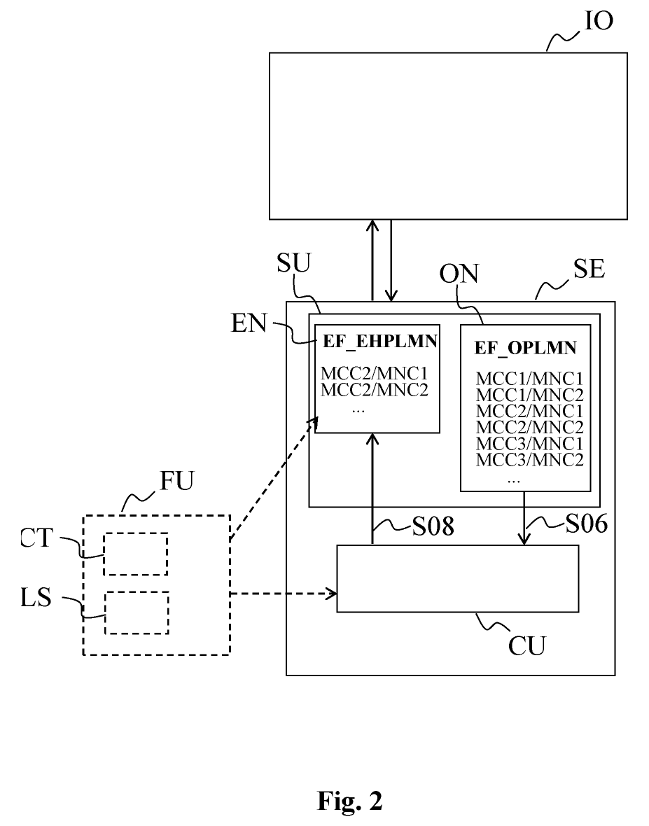

If the new country identifier CC1 differs from the old or first country identifier CC1, the control device CU is configured to determine a network identifier for the new country identifier CC1 and to write this new network identifier into the home network configuration HN in method step S08. This functionality of the control device CU which relates to the core of the invention is described in more detail with reference to FIG. 2.

In the second state, shown at the bottom right of FIG. 1, the home network configuration HN consequently further contains the new network identifier, e. g., in the elementary file EF_EHPLMN.

FIG. 2 shows a schematic illustration of a secure element SE which is communicatively integrated or connected into a terminal device TD according to an aspect of the invention.

The process of determining the new network identifier and writing the new network identifier into the home network configuration HN is shown in detail in the exemplary embodiment of the secure element SE according to FIG. 2. As shown in FIG. 2, the secure element SE may be connected to a transceiver IO. Furthermore, the secure element SE, shown as purely optional in FIG. 2, may be connected to a functional unit FU.

The secure element SE may receive a new country identifier from the transceiver IO and/or the functional unit FU, for example during a registration attempt in a communication network. In the present example, the secure element SE or the control device CU thereof may receive the new country identifier “MCC2”, while a different country identifier is stored in the memory area SU of the secure element SE (not shown). As shown in FIG. 2, the control device CU may thereupon read the operator-controlled network configuration ON, for example, in order to determine which network identifiers are suitable for the new country code “MCC2”. In the present example, these are the network identifiers “MCC2/MCN1” and “MCC2/MCN2”, that is to say two different network identifiers for the same country code “MCC2”. The control device CU may be configured to copy the two determined network identifiers from the elementary file EF_OPLMN of the operator-controlled network configuration ON and to insert them into the home network configuration HN, e. g., into the list of equivalent home networks EN. The list of equivalent home networks EN may be present as the elementary file EF_EHPLMN. The control device CU may be configured to insert the determined network identifiers in the first place of the elementary file EF_EHPLMN.

When continuing the registration attempt, for example, by a restart of the secure element SE or by a file change notification by the transceiver IO, the transceiver may search primarily for the network identifiers determined for the new country code “MCC2” and therefore register the terminal device considerably more quickly in a new communication network.

Optionally, the secure element SE may further be connected to an external functional unit FU. The functional unit FU may be integrated in the terminal device TD or even be external to the terminal device. The functional unit FU may comprise its own control device CT and a sensor unit. A location sensor LS is illustrated by way of example as a sensor unit in FIG. 2.

If the functional unit FU comprises a location sensor LS, the control device CT of the functional unit FU may be configured to determine or determine a new country identifier, such as “MCC2”, on the basis of a location signal of the location sensor LS. The functional unit FU, in particular the control device CU thereof, may be configured to transmit the new country identifier to the control device CU of the secure element SE. The functional unit FU, in particular the control device CU thereof, may be configured to determine at least one new network identifier on the basis of the new country identifier and to transmit the at least one new network identifier to the control device CU of the secure element SE. The functional unit FU, in particular the control device CU thereof, may be configured to write the at least one new network identifier directly into the home network configuration HN, in particular into the elementary file EF_EHPLMN, of the secure element SE.

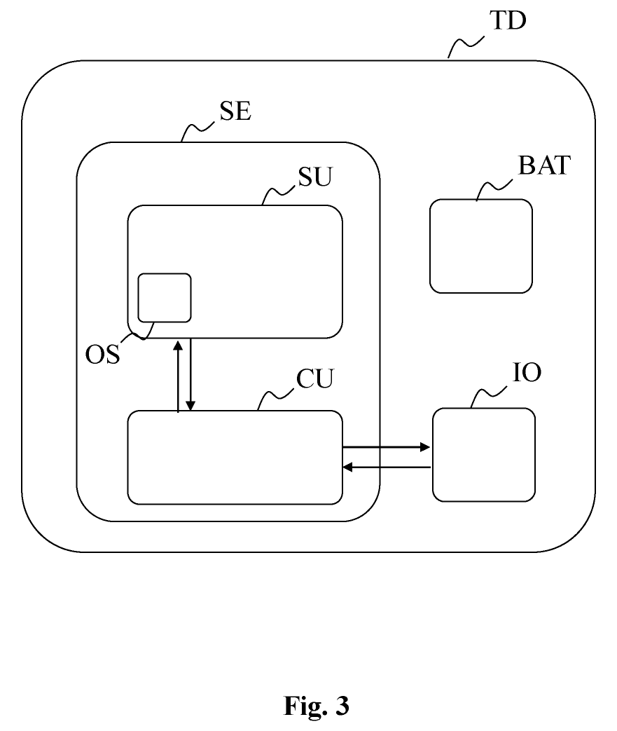

FIG. 3 shows a schematic illustration of a terminal device TD according to an aspect of the disclosure. The terminal device TD may also be configured or referred to as a terminal device.

The terminal device TD comprises a secure element SE, in particular as described above with reference to FIGS. 1 and 2. The terminal device TD comprises a transceiver IO, for example, a modem. The terminal device TF further comprises a battery BAT for supplying the secure element SE, the transceiver IO, and an optional functional unit (FU, see FIG. 2) with electrical energy. For instance, the battery is a primary battery that is not rechargeable. This results in a great benefit of the secure element according to an aspect of the invention since, on account of saved connection attempts, the battery storage lasts longer and as a result ultimately the runtime of the terminal device TD can be substantially extended.

The communication between the secure element SE and the transceiver IO is explained above with reference to FIG. 2.

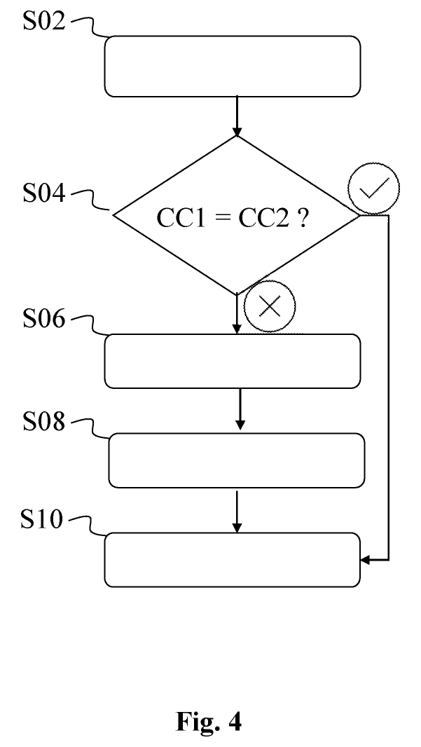

FIG. 4 shows a flowchart of a method for configuring a network search according to an aspect of the disclosure.

In a first method step S02, a new country identifier CC2 is received. The new country identifier CC2 may be received by a transceiver IO to which the secure element SE is connected and/or by a functional unit FU to which the secure element SE is connected.

In a second method step S04, the new country identifier CC2 is compared with a country identifier CC1 stored in the memory area SU of the secure element SE. In this case, it may be established that the two country identifiers CC1, CC2 are identical. This case is illustrated in FIG. 4 by a circled check mark. In this case, the method is continued directly with the fifth method step S10. If, on the other hand, it is established that the new country identifier CC2 differs from the stored country identifier CC1, the method is continued with the third method step S06. This case is illustrated in FIG. 4 by a circled “X”.

In a third method step S06, a new network identifier is determined on the basis of the new country identifier CC2. For this purpose, the list of registered roaming partners, that is to say EF_OPLMN, can be read out. As a rule, one or more network identifiers can be found or determined for the new country identifier CC2.

In a fourth method step S08, the at least one new network identifier, each of which corresponds to the new country identifier CC2 or comprises the latter, is written into the home network configuration HN. For instance, the at least one new network identifier is written into the list of equivalent home networks EN. For instance, the at least one new network identifier is written in the first place of the elementary file EHPLMN, also referred to as EF_EHPLMN.

In a fifth method step S10, the registration process is continued. This process may comprise a REFRESH of the secure element.

The method is configured for execution in a secure element SE, for example as described with reference to FIGS. 1 and 2. For this purpose, a machine-readable code may be provided, for example as a JavaCard applet for the control device CU, which contains instructions which, when executed by the secure element, cause the latter to carry out the method.

Alternatively or additionally, the method may be configured for execution in a terminal device TD, in particular in interaction of the secure element SE with a functional unit FU and/or a transceiver IO.

### Reference signs

TD Terminal device

IO Transceiver

SE Secure element

SU Memory area

HN Home network configuration

EN List of equivalent home networks

ON Operator-controlled network configuration

CC1 stored country identifier

CC2 new country identifier

CU Control device of the secure element

BAT Battery

FU Functional unit

CT Control device of the functional unit

LS Location sensor

S02 Method step “receiving a new country identifier”

S04 Method step “comparing the new country identifier with the stored country identifier”

S06 Method step “determining a new network identifier”

S08 Method step “writing the new network identifier into the home network configuration”

S10 Method step “continuing the registration attempt”

1. A secure element for communication via a communication network, wherein the secure element comprises:
a memory area in which a home network configuration (HN) and a country identifier are stored; and
a control device configured to:
receive a new country identifier during a registration attempt into the communication network,
if the new country identifier differs from the stored country identifier, write a network identifier corresponding to the new country identifier into the home network configuration, and
continue the registration attempt.

2. The secure element according to claim 1, wherein an operator-controlled network configuration is further stored in the memory area, and
the control device is configured to determine the network identifier corresponding to the new country identifier on the basis of the operator-controlled network configuration.

3. The secure element according to claim 2, wherein the operator-controlled network configuration comprises a list of network identifiers which each correspond to a country identifier from a plurality of country identifiers.

4. The secure element according to claim 1, wherein the control device is configured to receive the network identifier from outside the secure element.

5. The secure element according to claim 1, wherein the home network configuration comprises a list of equivalent home networks and wherein the control device is configured to write the network identifier into the list of equivalent home networks.

6. The secure element according to claim 5, wherein the control device is configured to copy at least one network identifier of the operator-controlled network configuration, the country identifier of which corresponds to the new country identifier, from the operator-controlled network configuration into the list of equivalent home networks.

7. The secure element according to claim 1, wherein the control device is configured to continue the registration attempt directly after the reception of the new country identifier if the new country identifier is identical to the stored country identifier.

8. A terminal device, comprising:
a secure element according to claim 1;
a battery; and
a transceiver for communication via the communication network, which is configured to search for networks and to determine the new country code.

9. The terminal device according to claim 8, further comprising a functional unit which comprises a control device and a location sensor,
wherein the control device of the functional unit is configured to receive a location signal of the location sensor, to determine the new country identifier on the basis of the location signal and to provide the new country identifier to the secure element.

10. The terminal device according to claim 9, wherein the control device of the functional unit is further configured to determine, on the basis of the location signal, the new country identifier in each case for the current country and at least one neighboring country and to provide the determined new country identifiers to the secure element.

11. The terminal device according to claim 9, wherein the control device of the functional unit is further configured to transmit the new country identifier or the new country identifiers to the control device of the secure element.

12. The terminal device according to claim 9, wherein the control device of the functional unit is further configured to write the network identifier corresponding to the new country identifier directly into the list of equivalent home networks.

13. A method for configuring a network search for a registration attempt of a secure element into a communication network, the method comprising:
receiving a new country identifier;
comparing the new country identifier with a country identifier stored in the secure element;
if the new country identifier differs from the stored country identifier:
determining a network identifier corresponding to the new country identifier; and
writing the network identifier into the home network configuration.

14. The method according to claim 13, further comprising:
determining the network identifier corresponding to the new country identifier on the basis of an operator-controlled network configuration which is stored in the secure element; and/or
writing the network identifier into a list of equivalent home networks which is stored in the secure element.

15. The method according to claim 13, further comprising determining the new country identifier by a transceiver.

16. The method according to claim 15, wherein determining the new country identifier by the transceiver during the network search.

17. The method according to claim 13, further comprising determining the new country identifier by a functional unit outside the secure element on the basis of a location signal.

18. The method according to claim 13, further comprising copying at least one network identifier of the operator-controlled network configuration, the country identifier of which corresponds to the new country identifier, from the operator-controlled network configuration into the list of equivalent home networks.

19. The method according to claim 18, wherein the operator-controlled network configuration is stored in the elementary file OPLMN.

20. The method according to claim 18, wherein the list of equivalent home networks is stored in the elementary file EHPLMN.
